(19) United States
(12) Patent Application Publication
(10) Pub. No.: US 2021/0350989 A1
(43) Pub. Date: Nov. 11, 2021

(54) ELECTROMAGNETIC DRIVE FOR A POWER CIRCUIT-BREAKER WITH A VACUUM INTERRUPTER

(71) Applicant: SIEMENS AKTIENGESELLSCHAFT, MUENCHEN (DE)

(72) Inventors: LOKESH KUMAR, ALIGARH (IN); RALF TSCHIESCHE, BERLIN (DE)

(21) Appl. No.: 17/316,911

(22) Filed: May 11, 2021

(30) Foreign Application Priority Data
May 11, 2020 (DE) 102020205869.5

(51) Int. Cl. H01H 33/666; H01H 3/28; H01H 1/20

(52) U.S. Cl. CPC H01H 33/6662; H01H 1/2025; H01H 3/28

(57) ABSTRACT

A drive unit is provided for a moving contact of a vacuum tube. The drive unit has a tube pin which is conductively connected to the moving contact, a drive which is connected to the tube pin, and a conductor bridge. The drive moves the tube pin. The conductor bridge is directly conductively connected to the tube pin and a stationary conductor and bridges a travel of the tube pin between a conductive switching state of the vacuum tube and a non-conductive switching state. A magnet drive is provided, which contains a first magnet element, which is connected to the tube pin, and a second magnet element. The two magnet elements are configured to build up a magnetic force between them when current is flowing through the vacuum tube and in this way generates a contact-pressure force of the moving contact onto a fixed contact of the vacuum tube.

### CROSS-REFERENCE TO RELATED APPLICATION

This application claims the priority, under 35 U.S.C. § 119, of German patent application DE 10 2020 205 869.5, filed May 11, 2020; the prior application is herewith incorporated by reference in its entirety.

### BACKGROUND OF THE INVENTION

### Field of the Invention

The invention relates to a drive unit for a moving contact of a vacuum tube, to a circuit breaker containing such a drive unit, and to a gas-insulated or air-insulated switchgear assembly containing such a circuit breaker.

Vacuum tubes are used in gas-insulated and air-insulated switchgear assemblies in order to switch currents. In particular, vacuum tubes are used in the medium-voltage sector (usually voltages of between 1 kV and 52 kV) and the high-voltage sector (usually voltages of over 52 kV), but vacuum tubes are also used in the low-voltage sector (voltages less than 1 kV) in order to switch currents above 1 kA.

A vacuum tube usually contains a fixed contact and a moving contact which is arranged at one end of a tube pin, which fixed contact and moving contact are physically remote from one another in the non-conductive switching state of the vacuum tube and lie one on the other in the conductive switching state of the vacuum tube.

The low density of ionizable particles in the interior of the vacuum tube helps to suppress arcs during switching processes. Since a complete vacuum cannot be technically generated in principle, it is however possible for an undesired arc to still be produced given high voltages and currents and a small distance between the fixed contact and the moving contact, which arc can damage the contacts due to material removal at the surfaces of the contacts and, due to the material released in the process, can promote the formation of a stronger arc. For this reason, the moving contact is moved as quickly as possible in order to keep the time period until complete contact is established as low as possible. It is customary in the art to use, with preference, spring mechanisms, but also electromagnetic drives, for this purpose.

However, on account of its high movement speed, the moving contact may bounce back from the fixed contact, so that the contact just established briefly reopens. In addition, in particular when used as a grounding switch or short-circuiting unit, forces which counteract the drive moving the moving contact may be created on account of the high short-circuiting current briefly flowing in the event of first contact between the two contacts and inductances which are always present. Each time the moving contact lifts off, intensive arcs are produced which can lead to the formation of heat and even to welding of the contacts to one another.

### BRIEF SUMMARY OF THE INVENTION

Therefore, the object of the invention is to introduce an improved drive unit for a moving contact of a vacuum tube, which moving contact allows contact to be made in a reliable manner between the moving contact and the fixed contact.

A first aspect of the invention achieves this object by way of a drive unit for a moving contact of a vacuum tube according to the independent claim. The dependent claims relate to preferred embodiments of the invention.

The drive unit for a moving contact of a vacuum tube has at least a tube pin which is or can be conductively connected to the moving contact, a drive which is connected to the tube pin, and a conductor bridge. The tube pin is preferably arranged such that it can move along its longitudinal axis. The drive is configured to move the tube pin along a movement direction. In this way, the drive can move the moving contact of the vacuum tube, which moving contact is connected to the tube pin, in a corresponding manner, as a result of which the vacuum tube can be switched over between a non-conductive switching state (open switch) and a conductive switching state (closed switch). The conductor bridge is directly or indirectly conductively connected to the tube pin and a stationary conductor and is configured to bridge a travel of the tube pin between the conductive switching state of the vacuum tube and the non-conductive switching state of the vacuum tube. For example, the conductor bridge can be manufactured as a stranded wire or a large number of thin sheets composed of copper or another conductive material. It is also possible to realize the conductor bridge by way of a sliding contact. Conductor bridges of this kind are well known in the technical field in question, and therefore a more detailed description can be dispensed with.

According to the invention, a magnet drive is also provided, which contains a first magnet element, which is mechanically connected to the tube pin, and a second magnet element. The second magnet element is preferably arranged in a stationary manner, but can also be mounted in a positionally variable manner, for example spring-mounted or mounted such that it can be pivoted by a drive. The two magnet elements are configured to build up a magnetic force between them when current is flowing through the vacuum tube and in this way to generate a contact-pressure force of the moving contact onto a fixed contact of the vacuum tube. In this case, one of the two magnet elements is a first coil through which a current flowing through the vacuum tube in the conductive switching state of the vacuum tube flows.

The drive unit according to the invention has the advantage that the first coil, at the moment at which the moving contact meets the fixed contact, builds up a correspondingly strong magnetic field with the incipient current through the coil, which magnetic field creates a magnetic force—an attracting or repelling magnetic force depending on the configuration—between the two magnet elements. In this case, the two magnet elements are arranged relative to one another such that the attracting or repelling magnetic force creates a contact-pressure force of the moving contact onto the fixed contact of the vacuum tube. This is therefore advantageous because this contact-pressure force exists only when current is flowing and in addition to the force provided by the drive of the drive unit, so that the magnet drive assists the drive of the drive unit with contact pressure of the moving contact. The drive of the drive unit can accordingly be produced with reduced expenditure, for example with comparatively weak springs, because it can be provided with a lower drive force, in particular spring force, than the prior art for the same contact-pressure force.

When the vacuum tube is used in a grounding switch, it is expected that the short-circuiting current will be interrupted by an interrupter or circuit breaker at another point of the current path after a short time, so that the drive can separate the now de-energized contacts of the vacuum tube from one another owing to the absence of the magnetic force once again using a low drive force, for example by a relatively weak auxiliary motor for tensioning a comparatively weak spring of the drive.

The other of the two magnet elements can be a second coil through which the current flowing through the vacuum tube in the conductive switching state of the vacuum tube flows. In this case, both magnet elements are designed as electromagnetic elements. Each of the two coils can be realized, for example, by a single conductor coil.

The first coil preferably has a first winding direction (sense) and the second coil preferably has a second winding direction which is opposite to the first winding direction. This creates a repelling magnetic force between the two coils, as a result of which particularly space-saving arrangements are possible. If, however, the tube pin is routed through the coil which functions as the second magnet element, so that the coil which is connected to the tube pin is arranged behind the coil which functions as the second magnet element as viewed from the vacuum tube, the two coils can also have the same winding direction and therefore create an attracting magnetic force between the coils. However, this embodiment requires increased structural outlay.

The other of the two magnet elements can comprise a ferromagnetic material or consist of a ferromagnetic material. When a soft-magnetic material is used, an attracting magnetic force can be produced between the two magnet elements. A contact-pressure force of the moving contact onto the fixed contact of the vacuum tube can be created by appropriate physical arrangement of the two magnet elements. For example, the tube pin can be routed through the first coil which functions as the second magnet element in this case, and the ferromagnetic magnet element can be arranged behind the first coil as viewed from the vacuum tube. As an alternative, the first coil can be arranged on the tube pin and the ferromagnetic element which functions as the second magnet element in this case can be arranged in front of the first coil as viewed from the vacuum tube.

The other of the two magnet elements can also be a permanent magnet. Such a configuration may be expedient in DC voltage applications in which the direction of flow of the direct current is known and the orientation of the north and the south pole of the permanent magnet can be selected in a corresponding manner because, in comparison to the use of a soft-magnetic material, time required for the magnetization can be dispensed with and the magnetic force can act immediately.

The two magnet elements are preferably arranged offset in relation to one another along the longitudinal axis of the tube pin. In this case, the magnetic force which exists between the two magnet elements acts immediately in the movement direction of the tube pin and therefore of the moving contact of the vacuum tube.

The two magnet elements are preferably arranged coaxially in relation to one another. In this arrangement, the magnetic effect between the two magnet elements is at a maximum.

In particularly preferred embodiments of the invention, the two magnet elements are arranged coaxially in relation to one another, wherein a circumference of a selected magnet element of the two magnet elements and a cutout area of a remaining magnet element of the two magnet elements are selected such that the selected magnet element can be at least partially displaced through the remaining magnet element. This can create a lateral overlap between the two magnet elements, so that a particularly large magnetic force can be generated.

A further aspect of the invention introduces a circuit breaker containing at least a vacuum tube and a drive unit for a moving contact of the vacuum tube according to the first aspect of the invention.

The circuit breaker can be configured, in particular, as a grounding switch or short-circuiting device.

A further aspect of the invention relates to a gas-insulated or air-insulated switchgear assembly comprising such a circuit breaker.

All aspects of the invention are preferably used in the field of medium-voltage or high-voltage engineering applications but can also be used in low-voltage engineering if large currents (in particular greater than 1 kA) are intended to be switched.

Other features which are considered as characteristic for the invention are set forth in the appended claims.

Although the invention is illustrated and described herein as embodied in an electromagnetic drive for a power circuit-breaker with a vacuum interrupter, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a schematic illustration of a circuit breaker having a vacuum tube according to the prior art;

FIG. 2 is a perspective view of a first exemplary embodiment of a magnet drive according to the invention for a moving contact of the vacuum tube;

FIG. 3 is a perspective view of a second exemplary embodiment of the et drive according to the invention for the moving contact of the vacuum tube;

FIG. 4 is a perspective view of a third exemplary embodiment of the magnet drive according to the invention for the moving contact of the vacuum tube;

FIG. 5 is a perspective view of a fourth exemplary embodiment of the magnet drive according to the invention for the moving contact of the vacuum tube; and

FIG. 6 is an illustration of an exemplary embodiment of a gas-insulated or air-insulated switchgear assembly containing circuit breakers according to the invention which are interconnected to form a grounding switch.

### DETAILED DESCRIPTION OF THE INVENTION

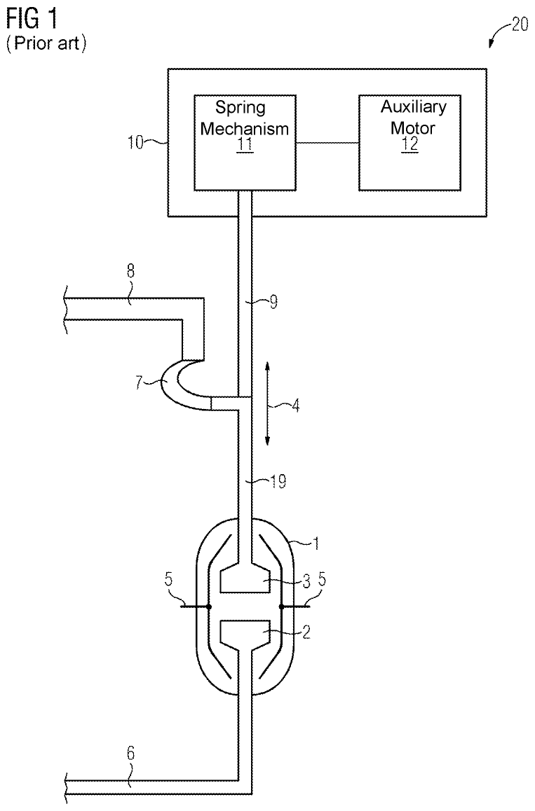

Referring now to the figures of the drawings in detail and first, particularly to FIG. 1 thereof, there is shown a schematic illustration of a circuit breaker 20 containing a vacuum tube 1 according to the prior art. The vacuum tube 1 is configured as a mechanical switch which establishes or interrupts an electrically conductive contact by way of a moving contact 3, which is arranged at one end of a tube pin 19, moving along a movement direction 4 indicated in the figure and as a result coming into conductive contact with a fixed contact 2 (establishing a conductive switching state) or else being moved away from the fixed contact 2 again (establishing a non-conductive switching state).

The vacuum tube 1 constitutes the central switching element of the circuit breaker 20. A low pressure prevailing in the interior of the vacuum tube 1 largely suppresses the production of arcs in this case. It is customary in the art for the vacuum tube to be dimensioned depending on the voltages and currents switched. For example, an electrode 5 can be provided for a mid-potential in order to reduce potential differences within the vacuum tube 1 and therefore to be able to switch larger voltages given the same size of vacuum tube 1.

The vacuum tube 1 is connected to first and second fixed conductors 6 and 8, wherein the connection in the case of the moving contact 3 takes place via a conductor bridge 7 which compensates for the travel of the moving contact 3 or of the tube pin 19 between the conductive and the non-conductive switching state. It is customary in the art for the conductor bridge 7 to be able to be manufactured, for example, as a stranded wire or else as a large number of thin strips composed of a conductive material, such as copper, which are laid one above the other and can be displaced in relation to one another. However, the use of a sliding contact for a conductor bridge is also conceivable.

The tube pin 19 is connected by means of an insulator 9 to a drive 10 which moves the tube pin 19 and therefore the moving contact 3 in order to switch over the vacuum tube 1 between the two switching states. In the exemplary embodiment shown, the drive 10 contains a spring mechanism 11, which can quickly drive the tube pin 19 by spring force, and an auxiliary motor 12 which is connected to the spring mechanism 11 and is intended to tension one or more springs (not illustrated) of the spring mechanism 11 for further tripping of the spring mechanism 11. However, the drive 10 can also have an electrical or electromagnetic drive instead of the spring mechanism 11 and a rechargeable electrical energy store instead of the auxiliary motor 12.

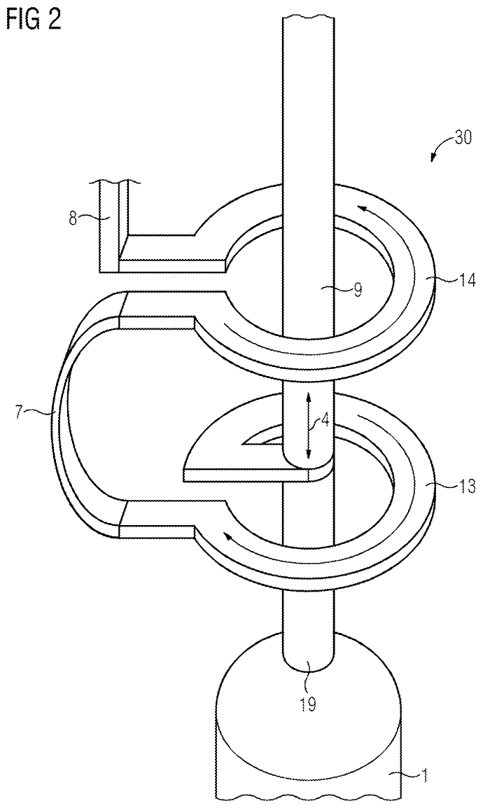

FIG. 2 shows a first exemplary embodiment of a magnet drive 30 according to the invention for a moving contact 3 of a vacuum tube 1. The magnet drive 30 according to the invention is combined with a drive (not illustrated) which can be constructed, for example, like the drive 10 of the example shown in FIG. 1 known from the prior art. The magnet drive 30 according to the invention is configured to apply an (additional) contact-pressure force to a moving contact which is located in the interior of a vacuum tube 1 and is arranged at one end of a tube pin 19 when a current is flowing through the vacuum tube 1. In this case, the tube pin 19 can be electrically insulated from the drive (spring mechanism etc.) by an insulator 9. However, it is also possible to electrically conductively connect the drive to the tube pin 19 and to electrically insulate the drive from its further environment for this purpose. However, this increases the total outlay on insulation and the quantity of voltage-carrying and therefore potentially hazardous components.

The magnet drive 30 has two magnet elements which are configured as a first coil 13 and a second coil 14 in the present case. In the example shown, the first coil 13 is electrically conductively and mechanically connected to the tube pin 19 and accordingly moves with the tube pin 19. In contrast, the second coil 14 is stationary and connected to a second fixed conductor 8. In order to compensate for a travel of the tube pin 19, a conductor bridge 7 which electrically conductively connects the first coil 13 to the second coil 14 is provided, as in the prior art.

In the example shown, the first coil 13 and the second coil 14 each comprise only one conductor coil, but can also be embodied with more conductor coils, depending on the desired magnetic and therefore contact-pressure force. In the exemplary embodiment of FIG. 2, the winding direction of the two coils and therefore the directions of flow of current through the two coils are opposite to one another, this being illustrated by corresponding arrows in the drawing. In the physical arrangement shown, this creates a repelling magnetic force between the two coils when current is flowing, irrespective of the direction. However, as an alternative, it is also possible to arrange the stationary coil (here the second coil 14) between the coil which is connected to the tube pin 19 (here the first coil 13) and the vacuum tube 1. In this case, an attracting magnetic force between the two coils 13, 14 which function as magnet elements is desirable, so that the coils 13, 14 should have winding directions directed in the same way in this case.

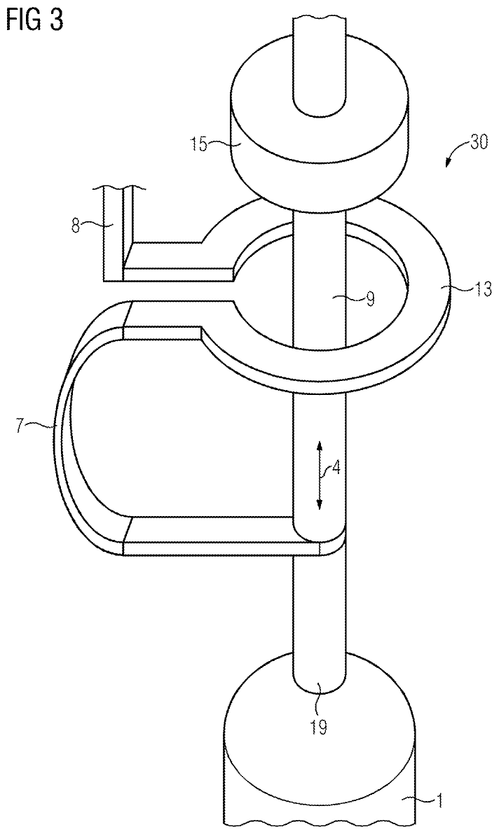

FIG. 3 shows a second exemplary embodiment of the magnet drive 30 according to the invention for a moving contact of a vacuum tube 1. The statements made in relation to the first exemplary embodiment of FIG. 2 can be applied to the second exemplary embodiment, provided that nothing different is disclosed below. In the second exemplary embodiment, only one of the two magnet elements to be provided according to the invention is embodied as a coil, specifically the first coil 13, which here is embodied in a stationary manner and in a manner electrically conductively connected to the second fixed conductor 8. A ferromagnetic body 15 which consists of ferromagnetic material or contains such a material is used as the second magnet element. The ferromagnetic material is preferably a soft-magnetic material, but may also be hard-magnetic, and therefore the second magnet element may be a permanent magnet. Use of a permanent magnet may be advantageous, for example, in DC applications. The use of the insulator 9 shown is not absolutely necessary in the second exemplary embodiment either.

In the exemplary embodiment shown in FIG. 3, the first coil 13 is arranged in a stationary manner and the ferromagnetic material 15 is arranged such that it can move with the tube pin 19. However, it is equally readily possible to combine a moving coil with a stationary body composed of ferromagnetic material. In principle, it is generally also conceivable within the scope of the invention to provide a positionally variable magnet element, which is mounted in such a way that it can counter a mechanical force of a particular strength, instead of a stationary magnet element. For example, the positionally variable magnet element can be mounted with a spring action, in a pivotable manner or such that it can be moved by a dedicated drive. However, embodiments of this kind are associated with increased structural outlay.

Within the scope of the invention, it is possible to provide more than two magnet elements, for example by way of the exemplary embodiments of FIGS. 2 and 3 being combined with one another, so that the magnetic force acts first between one or more coils as a (possibly combined) first magnet element and second one or more coils and at least one body composed of ferromagnetic material as a second combined magnet element. Such a combination may be advantageous, for example, if, when a soft-magnetic material is used, on account of the time period required for the magnetization of the soft-magnetic material, the magnetic effect of the soft-magnetic material occurs with a slight time delay, so that the time profile of the active magnetic force can be dynamically adapted to a bouncing behavior of the moving contact on the fixed contact.

Each coil can also be provided with a ferromagnetic coating which is preferably electrically isolated from the coil by an insulator. In this case, the ferromagnetic coating is magnetized by the magnetic field of the coil when a current is flowing and can therefore maintain the magnetic field and therefore the contact-pressure force for a certain time after the flow of current ends.

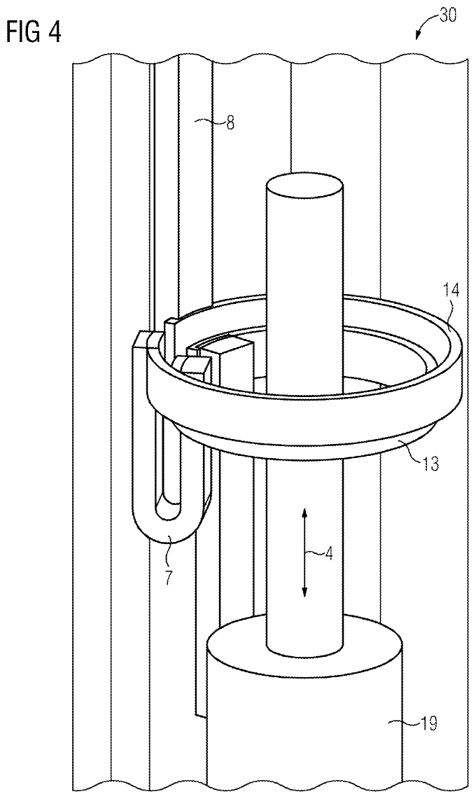

FIG. 4 shows a third exemplary embodiment of the magnet drive 30 according to the invention for a moving contact of a vacuum tube 1. The third exemplary embodiment is similar to the first exemplary embodiment shown in FIG. 2, but achieves a considerably larger contact-pressure force owing to the smaller distances between the first coil 13 and the second coil 14. In addition, the first coil 13 and the second coil 14 overlap horizontally since the outside diameter of the first coil 13 is selected such that it is smaller than the inside diameter of the second coil 14, so that the first coil 13 is arranged and displaceable within the second coil 14. In this way—as mentioned—first the repelling magnetic force is increased and secondly installation space is saved. It goes without saying that the stationary coil can, as an alternative, also be arranged within the moving coil here.

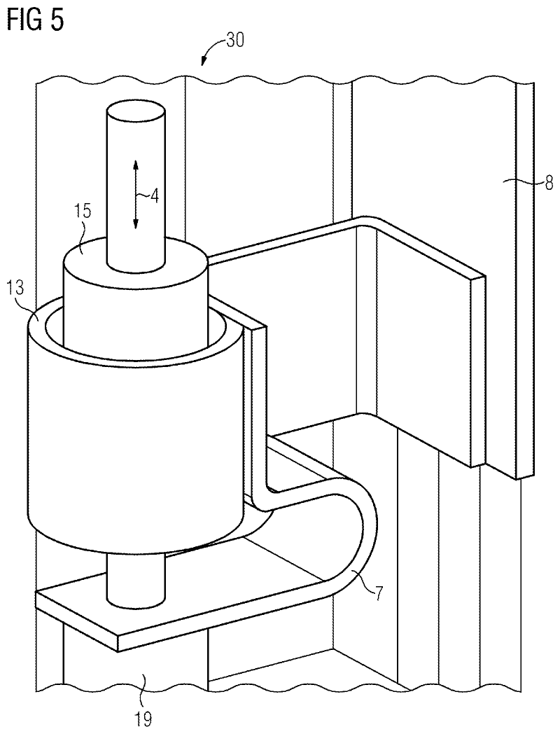

FIG. 5 shows a fourth exemplary embodiment of the magnet drive 30 according to the invention for the moving contact of the vacuum tube 1. The fourth exemplary embodiment is similar to the second exemplary embodiment shown in FIG. 3, wherein—like the exemplary embodiment of FIG. 4—the first coil 13 and the ferromagnetic body 15 are arranged in an overlapping manner and such that they can be displaced one in the other here, as a result of which the same advantages as explained for the exemplary embodiment shown in FIG. 4 are achieved. In addition, as explained for the exemplary embodiment of FIG. 3, the ferromagnetic body 15 can, as an alternative, be arranged in a stationary manner and the coil 13 can be arranged in a movable manner.

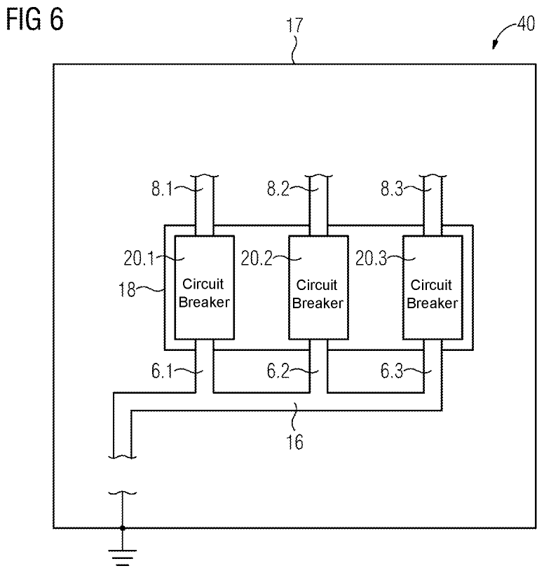

FIG. 6 shows an exemplary embodiment of a gas-insulated or air-insulated switchgear assembly 40 which can be configured, in particular, for a medium or high voltage. The switchgear assembly 40 has circuit breakers 20.1, 20.2, 20.3 according to the invention which are interconnected to form a three-phase grounding switch 18. Each of the three circuit breakers 20.1, 20.2, 20.3 is connected to corresponding first fixed conductors 6.1, 6.2, 6.3 and second fixed conductors 8.1, 8.2, 8.3. The first fixed conductors 6.1, 6.2, 6.3 are connected to one another and to ground potential by way of a common grounding conductor 16. The grounding conductor 16 can also be dispensed with, as a result of which the arrangement can serve as a short-circuiting unit. A grounding switch and a short-circuiting unit can be used in order to initiate rapid disconnection of the flow of current by an interrupter (circuit breaker) at another point of the energy supplying network. The grounding switch 18 is arranged in a housing 17 which can be filled with a technical gas or air. When a technical gas is used for insulation, the housing 17 is gas-insulated. When air is used as the insulator, this outlay can be dispensed with, but air provides poorer insulation and protection properties, and for this reason lower voltages can usually be switched than when using suitable technical gases given the same space requirement.

The invention has been described in more detail with reference to exemplary embodiments which, however, are not to be interpreted as limiting the scope of protection, which is defined solely by the following patent claims, and serve merely for better understanding of the invention.

### LIST OF REFERENCE SYMBOLS

1 Vacuum tube
2 Fixed contact
3 Moving contact
4 Movement direction
5 Electrode
6 First fixed conductor
7 Conductor bridge
8 Second fixed conductor
9 Insulator
10 Drive
11 Spring mechanism
12 Auxiliary motor
13 First coil
14 Second coil
15 Ferromagnetic body
16 Grounding conductor
17 Housing
18 Grounding switch
19 Tube pin
20 Circuit breaker
30 Magnet drive
40 Switchgear assembly

1. A drive unit for a moving contact of a vacuum tube, the drive unit comprising:
a tube pin which is or can be conductively connected to the moving contact;
a drive connected to said tube pin and configured to move said tube pin along a movement direction;
a conductor bridge directly or indirectly conductively connected to said tube pin and a stationary conductor, said conductor bridge bridging a travel of said tube pin between a conductive switching state of the vacuum tube and a non-conductive switching state of the vacuum tube; and
a magnet drive having a first magnet element, being mechanically connected to said tube pin, and a second magnet element, wherein said first and second magnet elements are configured to build up a magnetic force between them when current is flowing through the vacuum tube and in this way generating a contact-pressure force of the moving contact onto a fixed contact of the vacuum tube, and wherein one of said first and second magnet elements is a first coil through which the current flowing through the vacuum tube in the conductive switching state of the vacuum tube flows.

2. The drive unit according to claim 1, wherein an other of said first and second magnet elements is a second coil through which the current flowing through the vacuum tube in the conductive switching state of the vacuum tube flows.

3. The drive unit according to claim 1, wherein said first coil has a first winding direction and said second coil has a second winding direction which is opposite to the first winding direction.

4. The drive unit according to claim 1, wherein an other of said first and second magnet elements has a ferromagnetic material or is formed from said ferromagnetic material.

5. The drive unit according to claim 1, wherein an other of said first and second magnet elements is a permanent magnet.

6. The drive unit according to claim 1, wherein said first and second magnet elements are disposed offset in relation to one another along a longitudinal axis of said tube pin.

7. The drive unit according to claim 1, wherein said first and second magnet elements are disposed coaxially in relation to one another.

8. The drive unit according to claim 1, wherein a circumference of a selected one of said first and second magnet elements and a cutout area of a remaining one of said first and second magnet elements are selected such that said selected magnet element can be at least partially displaced through said remaining magnet element.

9. A circuit breaker, comprising:
a vacuum tube having a moving contact and a fixed contact;
a drive unit for said moving contact of said vacuum tube, said drive unit containing:
a tube pin which is or can be conductively connected to said moving contact;
a drive connected to said tube pin and configured to move said tube pin along a movement direction;
a conductor bridge directly or indirectly conductively connected to said tube pin and a stationary conductor, said conductor bridge bridging a travel of said tube pin between a conductive switching state of said vacuum tube and a non-conductive switching state of said vacuum tube; and
a magnet drive having a first magnet element, being mechanically connected to said tube pin, and a second magnet element, wherein said first and second magnet elements are configured to build up a magnetic force between them when current is flowing through said vacuum tube and in this way generates a contact-pressure force of said moving contact onto said fixed contact of said vacuum tube, and wherein one of said first and second magnet elements is a first coil through which the current flowing through the vacuum tube in the conductive switching state of said vacuum tube flows.

10. A gas-insulated or air-insulated switchgear assembly for a medium or high voltage, comprising:
a circuit breaker according to claim 9.
